(19) United States
(12) Patent Application Publication
(10) Pub. No.: US 2018/0157717 A1
(43) Pub. Date: Jun. 7, 2018

(54) PhotoFracking - mining metadata from various / multiple sources to recreate an event, person, place or thing in time

(71) Applicants: William James Yurt, Maiden, NC (US); Dianne S. Yurt, Maiden, NC (US)

(72) Inventors: William James Yurt, Maiden, NC (US); Dianne S. Yurt, Maiden, NC (US)

(21) Appl. No.: 15/367,238

(22) Filed: Dec. 2, 2016

(51) Int. Cl. G06F 17/30

(52) U.S. Cl. CPC G06F 17/30539; G06F 17/30106

(57) ABSTRACT

When someone takes and posts an image of an event, person, place or thing, that ‘photo’ has that individual's perspective. With our patented pending process, “photofracking”, the photos from many other users will be “stitched” to create a unique virtual multidimensional view of that event in time.

This “fracking” process relies on the consistent metadata of an electronic image file, (still or otherwise) which is part of this process.

Our process will establish a CONSISTANT set of attributes that are captured as a part of the image (file). These attributes traverses operating system and hardware (i.e. phone, camera, computer, etc.) from which it was taken. The output is a viewable artifact and searchable metadata.

### OVERVIEW

This will be a phased approach to deliver a single iteration to show progress. This will move us toward the ultimate goal in being able to recreate a specific location through digital media which will provide the user a virtual perspective from all sources.

### IDEA

When someone takes and posts an image of an event, person, place or thing that ‘photo’ has the perspective of that user. Using the metadata we will investigate the possibilities of building a virtual perspective of that same event, person, place or thing.

For example: On vacation I take a picture of my children on the beach. That photo has metadata data that gives various additional pieces of information, like coordinates, date, time . . .

Someone else, at the same time, takes a picture from their hotel room overlooking that same beach where you and your kids just took, or had taken that photo.

By being able to combine and frack the metadata from those 2 pictures, we can create a much larger picture that could be viewed showing you taking that picture of your kids.

Today's technology captures all this information along with the image. Why not uses many sources, combining the many angles from any media that was at that same set of GPS coordinates? Not only could you recreate a much larger world snapshot than just your one photo, but over time this combined linage would catalog history of that same location.

The intent is to give a unique pictorial representation of any event, person, place or thing which could be used for many applications, not the least to provide enhanced memories of your event, person, place or thing which may have been captured from others.

(maybe come up with a new word, acronym of the “event, person, place or thing”)

We plan on investigating the feasibility to stitch these multi-media data from its metadata and build a virtual matrix, like perspective of that event, person, place or thing.

How is this metadata captured? Can it be saved, indexed effectively to provide a queryable database of event, person, place or thing . . .

Phase 1 investigation should be limited to a simple prototype and identifying other uses personally and commercially which could provide funding and or sales opportunities.

Phase 1 funding would be traded for future net sharing/ownership of any material, rights etc . . . that would be produced as a result of the work done to prove viability.

Creative input is also being solicited in the form of OS experts that can understand the associated file attributes of how media is captured and saved in various formats.

The financial impact would also be investigated during this initial phase . . .

Monthly reporting and updates are provided to non-contributing individuals and organizations.

1. Photofracking defined as locating and accessing metadata associated with digital media spanning all operating systems and hardware and using said metadata to create a viewable artifact and searchable data that corresponds to specific set of criteria for an event (i.e. date, time, GPS coordinates).

2. The intended use said artifact spans the entertainment possibilities of users being able to see their own images they took, combined with those from others that shared possibly a similar subject, angle, event place and time. This gives the user a multidimensional view and varied perspectives of said event, person, or place in time.

3. The said artifact will also be a valuable tool in recreating an event that was considered a disaster; natural or manmade kind. These images of before, during, and after the event can be ‘Fracked’ together which may lead to revealing the true cause of the disaster.
